(19) United States
(12) Patent Application Publication
(10) Pub. No.: US 2011/0144829 A1
(43) Pub. Date: Jun. 16, 2011

(54) COUNTERMEASURE SYSTEM FOR BIRDS

(75) Inventors: Chang Hwoi Kim, Daejeon (KR); Seop Hur, Daejeon (KR); Kwang Seop Son, Seoul (KR); Hyungki Cha, Daejeon (KR); Jung-Woon Lee, Daejeon (KR); Young-Soo Choi, Daejeon (KR); Kyung-min Jeong, Daejeon (KR); Sung-Uk Lee, Daejeon (KR); Tong-Il Jang, Daejeon (KR); Sung-Mo Nam, Daejeon (KR); Se-Woo Cheon, Daejeon (KR)

(73) Assignee: Korea Atomic Energy Research Institute, Daejeon (KR)

(21) Appl. No.: 12/883,616

(22) Filed: Sep. 16, 2010

(30) Foreign Application Priority Data
Dec. 10, 2009 (KR) 10-2009-0122507

(51) Int. Cl. G05D 1/00; G01S 13/56; G01S 13/00

(52) U.S. Cl. 701/2; 342/28; 342/53; 367/139

(57) ABSTRACT

Provided is a bird countermeasure system. The bird countermeasure system includes a bird countermeasure robot configured to be operated through a remote command while patrolling or moving in an area adjacent to a runway or taxiway along which airplanes take off, land or taxi so as to approach the runway or taxiway or to detect or repel birds located close to the runway or taxiway.

### CROSS-REFERENCE TO RELATED APPLICATION

This application claims the benefit under 35 U.S.C. §119 of Korean Patent Application No. 10-2009-0122507, filed on Dec. 10, 2009, which is hereby incorporated by reference in its entirety.

### BACKGROUND

1. Field of the Invention

The present invention relates to a bird countermeasure system, and more particularly, to a bird countermeasure system capable of preventing bird strikes with airplanes and minimizing learning by birds by combining a sound/laser-based up-to-date bird repellent scheme and an unmanned mobile robot scheme, which are applicable to actual conditions of civilian airports.

2. Discussion of the Background

Generally, effective bird repellents in airports remain an internationally unsolved problem. Bird strikes with airplanes cause serious damage in various ways, such as a decline of a public image of airports, in addition to human and property damage.

According to a 2003 report by the International Civil Aviation Organization (ICAO), more than 400 people were killed, and the complete destruction of 420 airplanes was caused by bird strikes. In addition, more than 90% of the bird strikes occur during take-off and landing.

Such problems similarly occur in Korean airports. Bird strikes frequently occurred at a height within about 300 m from the ground, and more than 40% of the bird strikes occurred at night.

The Federal Aviation Administration (FAA) reported that 6,360 bird strikes occurred in 2004. According to statistics, about 80,000 bird strikes related to civilian aircraft occurred from 1990 to 2007. In comparison with all flights, about one bird strike occurs per 10,000 flights. Despite a small number of accidents, an enormous toll on humans and an enormous amount of property damage may be caused depending on the type and severity of an accident.

Among existing bird repellent methods for preventing bird strikes, methods using roar bombs, manikins, megaphones, gongs, falcons and the like have instantaneous effects, however, the effects are limited because of learning by birds, and animosity of people may be increased due to an increase of private-sector housings near airports.

The operation of a bird alert team (BAT) in which people directly repel birds is one of the most effective methods that have been used to date. However, many people are used to cover the large area of an airport and thus, a sufficient number of BATs is not operated in most airports.

A bird repellent system using a sound is a system for preventing birds from gathering using a sound that annoys birds, and the bird repellent effect using a warning sound and a sound produce by a natural enemy of birds can be expected to be considerably improved. However, when another sound is used rather than the sound that annoys birds, a reverse effect may be produced in that birds may instead gather around the sound. While a sound suitable for characteristics of native birds is to be selected to be useful, the sound transmitted from a system for transmitting a sound produced by a natural enemy of birds, which is currently used as is in Korean airports, uses a sound aimed at foreign birds, and the system is also fixed at one location. Therefore, the repellent effect of native birds in airports is not sufficient.

A bird repellent system using a laser is only effective against birds up to a distance of around 2 or 3 km at sunrise, sunset, or night, and the effectiveness is insufficient in clear weather with a high intensity of sunlight. In Korea, the bird repellent system is not used at any airport and thus, its effect cannot be verified. Since the bird repellent system is a fixed type, its effect may be decreased in the case where it is continuously used at a fixed location.

Therefore, a bird repellent or countermeasure system capable of preventing the decrease of its effect due to the adaptation or learning by birds, and capable of continuously repelling birds, is desired.

### BRIEF SUMMARY

The present invention provides a bird countermeasure system capable of minimizing a learning effect of birds.

The present invention also provides a bird countermeasure system capable of preventing an unnecessary noise.

The present invention also provides a bird countermeasure system capable of improving stability by preventing that bird strikes with airplanes in an airport.

The present invention also provides a bird countermeasure system capable of tracking and repelling birds.

The present invention also provides a bird countermeasure system capable of repelling birds using various methods based on the type of bird, weather, time, and the like.

The present invention also provides a bird countermeasure system capable of minimizing operators used in the detection and repellent of birds, and capable of being used semi-permanently.

The present invention also provides a bird countermeasure system capable of determining whether to detect or repel birds in stages based on a distance from the birds.

Additional features of the invention will be set forth in the description which follows, and in part will be apparent from the description, or may be learned by practice of the invention.

According to an aspect of the present invention, there is provided a bird countermeasure system including a long-range bird countermeasure unit configured to detect birds located a long distance from an access point, a short-range bird countermeasure unit configured to detect or repel birds located a short distance from the access point, and a medium-range bird countermeasure unit configured to detect birds located between the long and short distances from the access point. In the bird countermeasure system, the long-range, medium-range and short-range bird countermeasure units are operated independently or in conjunction with each another.

The long-range bird countermeasure unit may detect birds flying toward the access point from the long distance using radar. The long-range bird countermeasure unit may detect the presence of a flock of the birds, the size of the flock of the birds or the flight pattern of the birds, and transmit the detected information to the access point.

Through the configuration described above, birds located a long distance can be detected from the access point such as an airport, and can be systematically detected or repelled based on whether the birds approach the access point. Also, it is possible to prevent the birds from approaching the access point by dealing with the birds from the long distance in advance.

The medium-range bird countermeasure unit may detect the type or size of birds and repels the birds at a point the birds are detected. That is, unlike the long-range countermeasure unit, the medium-range bird countermeasure unit may obtain more detailed information on the birds and determine whether to repel the birds using the obtained information.

The medium-range bird countermeasure unit may detect the birds using an infrared (IR) camera.

The short-range bird countermeasure unit may detect or repel the birds located at the access point or the short distance from the access point while patrolling or moving at the access point. That is, the short-range bird countermeasure unit may not be fixed to a specific location but actively search birds so as to detect or repel the birds that approach a hazard zone.

The short-range bird countermeasure unit may include a remote control station that remotely controls a robot moved from the access point and an operation of the robot. Accordingly, the short-range countermeasure unit is remotely controlled by the remote control station, so that an unmanned countermeasure system can be implemented, and operators used for the bird countermeasure system can be minimized.

The remote control station may control the operation of the robot through wireless communications with the robot, and diagnoses a malfunction of the robot may be performed through wireless communications. When the bird countermeasure robot malfunctions, the remote control station diagnoses the malfunction of the bird countermeasure robot, thereby stopping the operation of the bird countermeasure robot, and accordingly, it is possible to prevent the bird countermeasure robot from colliding with an airplane or the like.

The robot may operate only at a specific area in the access point and stop when the robot is out of the specific area. Accordingly, the robot is operated only in the specific area, so that it is possible to prevent the robot from approaching a runway or taxiway of an airplane and colliding with the airplane.

According to another aspect of the present invention, there is provided a bird countermeasure system including a bird countermeasure robot configured to be operated through a remote command while patrolling or moving in an area adjacent to a runway or taxiway along which airplanes take off, land, or taxi to approach the runway or taxiway or to detect or repel birds located close to the runway or taxiway.

The bird countermeasure robot may include a mobile platform configured to move in an area adjacent the runway or taxiway, a bird detection unit configured to be provided to the mobile platform and to detect the birds, a bird repellent unit configured to be provided to the mobile platform and to repel the birds detected by the bird detection unit, and a communication unit configured to transmit information detected by the bird detection unit.

By using an unmanned, semi-autonomous mobile robot configured as described above, the detection and countermeasure of birds may be smoothly performed, and the failure of repellent due to learning by the birds may be reduced.

The bird countermeasure robot may be provided with wheels or tracks and an obstacle/topography detection unit that detects and avoids an obstacle or topography located in front of a navigation path. Accordingly, through the obstacle/topography detection unit, the mobile platform can make a detour around a region in which it is difficult to move by detecting and avoiding an obstacle or topography that is expected to collide with the bird countermeasure robot.

The bird detection unit may detect the birds using at least one of an IR ray, a visual ray, and a sound. Accordingly, the bird detection unit detects birds using various methods or means, thereby continuously detecting the birds regardless of the time for detecting the birds, the type of the birds, and the like.

The bird detection unit may transmit image or sound information obtained by the communication unit to a remote control station. Accordingly, the remote control station can determine whether to repel birds and store the obtained information.

The bird repellent unit may repel the birds using at least one of a sound, a laser and a light. The bird repellent unit may repel the birds using different sounds based on the type of the birds or season. The bird repellent unit may repel the birds using a laser at night, sunset, or sunrise. Accordingly, by repelling birds using various methods described above, birds can be actively repelled based on the type or environment of the birds, and it is possible to prevent the birds from becoming accustomed to the bird repellent methods.

The bird repellent unit may automatically stop the irradiation of laser when the irradiation angle of the laser is a reference angle or more. The reference angle may be determined to be an angle that prevents interference with the sight of a pilot caused by a high irradiation of the laser for the bird repellent. When the irradiation angle of the laser is at an angle greater than the reference angle, the irradiation of the laser is stopped.

The operation of the bird countermeasure robot may be stopped when a communication error occurs between the bird countermeasure robot and the remote control station. When the bird countermeasure robot is operated or moved even though a communication error occurs between the remote control station and the bird countermeasure robot, the bird countermeasure robot may collide with an airplane by entering into a flight safety zone or restricted flight zone. In order to prevent such an accident, the operation of the bird countermeasure robot is stopped) when a communication error occurs between the bird countermeasure robot and the remote control station.

The location of the bird countermeasure robot may be detected in real time using a global positioning system (GPS), and the operation of the bird countermeasure robot may be stopped when the bird countermeasure robot approaches the runway or taxiway. Accordingly, a collision of the bird countermeasure robot with an airplane may be avoided by preventing, in real time, the bird countermeasure robot from entering into an access-restricted zone.

A plurality of bird countermeasure robots may be provided, and each of the bird countermeasure robots may be operated in a separate mission area so as to prevent an accident between the bird countermeasure robots.

The bird countermeasure robot may include a pan/tilt driving unit that drives the bird detection unit or the bird repellent unit on the mobile platform. By using the pan/tilt driving unit, the operation range of the bird detection unit or bird repellent unit can be maximized.

The bird countermeasure robot may stop operation and then returns to an initial location when an amount of fuel or charge of electricity is below a reference value. By returning to a predetermined location to refuel/recharge, it is possible to eliminate an inconvenience that operators are used to refuel/recharge.

The bird countermeasure robot may perform autonomous navigation by tracing a boundary line of the runway or taxiway. Accordingly, the bird countermeasure robot can autonomously distinguish between navigation and non-navigation areas. As a result, it is possible to prevent the bird countermeasure robot from colliding with an airplane.

It is to be understood that both the foregoing general description and the following detailed description are exemplary and explanatory and are intended to provide further explanation of the invention as claimed.

### EFFECT OF THE INVENTION

According to embodiments of the present invention, the learning effect of birds may be minimized by preventing the birds from becoming accustomed to the detection or repellent of the birds.

According to embodiments of the present invention, the popular complaints voiced by residents that reside around an airport may be reduced by preventing unnecessary noises.

According to embodiments of the present invention, since birds located a short distance are detected or repelled using an unmanned robot, operators used for a bird countermeasure system may be minimized, and thus, maintenance cost can be reduced.

According to embodiments of the present invention, there is provided a bird countermeasure robot that operates only in a fixed area and stops operation after traveling outside the fixed area, thereby may reduce a probability that the bird countermeasure robot may collide with an airplane.

According to embodiments of the present invention, since a bird countermeasure robot autonomously tracks birds while moving, the efficiency of bird detection or repellent may be increased.

According to embodiments of the present invention, a bird countermeasure robot uses various methods based on a type of birds, weather while operating, time while operating, and the like, thereby may minimize influences caused by circumstances while operating.

According to embodiments of the present invention, since a bird countermeasure system performs different countermeasures depending on the distance between an access point and birds, the bird countermeasure system may monitor the approach of the birds from a relatively long distance to the access point and use the monitored result, thereby enhancing bird repellent performance.

According to embodiments of the present invention, a bird countermeasure system warns a pilot against the appearance of birds in advance, so that it may be possible to prevent an airplane from colliding with the birds, and bird countermeasure operations may be variously performed from an airplane, a control tower, and a bird countermeasure robot.

### BRIEF DESCRIPTION OF THE DRAWINGS

FIG. 1 is a diagram schematically illustrating the configuration of a bird countermeasure system according to an embodiment of the present invention.

FIG. 2 is a perspective view illustrating a bird countermeasure robot according to an embodiment of the present invention.

FIG. 3 is a perspective view illustrating bird detection and repellent units of the bird countermeasure robot illustrated in FIG. 2.

FIG. 4 is a diagram illustrating an exemplary operation of the bird countermeasure robot illustrated in FIG. 2.

FIG. 5 is a block diagram illustrating the configuration of the bird countermeasure robot illustrated in FIG. 2.

FIG. 6 is a block diagram illustrating the configuration of a mobile platform of the bird countermeasure robot illustrated in FIG. 2.

FIG. 7 is a block diagram illustrating the configurations of the bird detection and repellent units of the bird countermeasure robot illustrated in FIG. 2.

FIG. 8 is a block diagram illustrating the configuration of a remote control station of the bird countermeasure system illustrated in FIG. 1.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

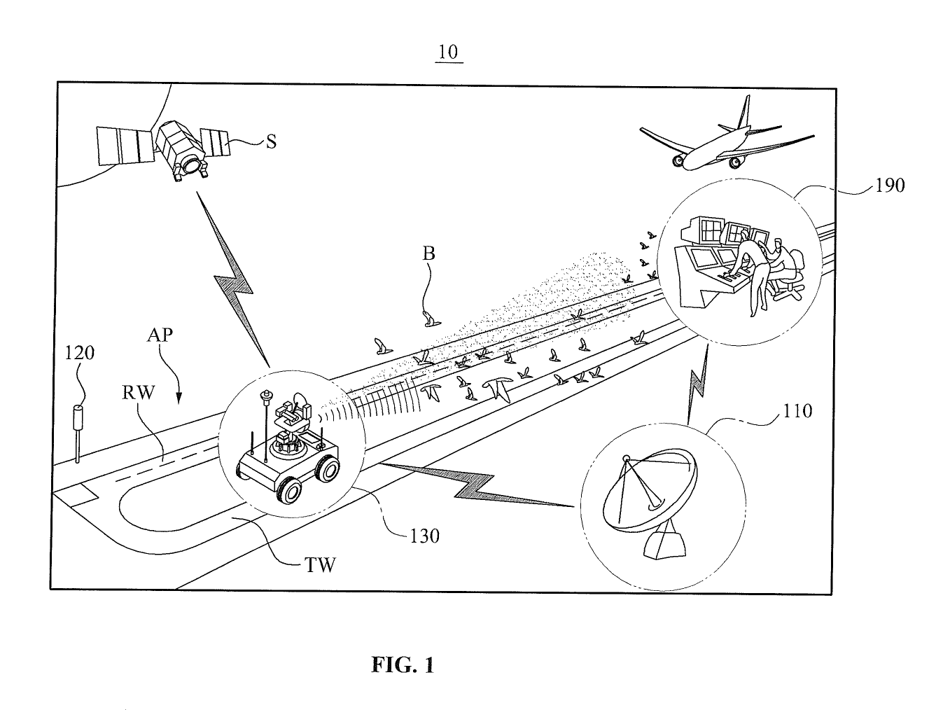

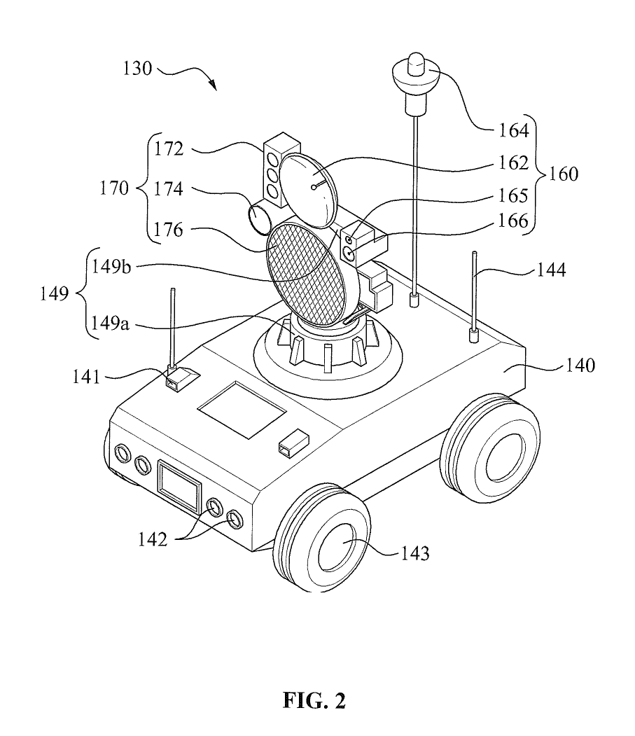

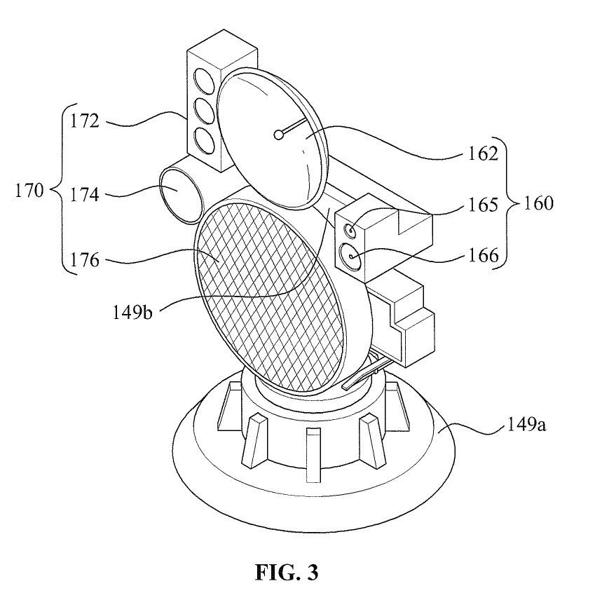

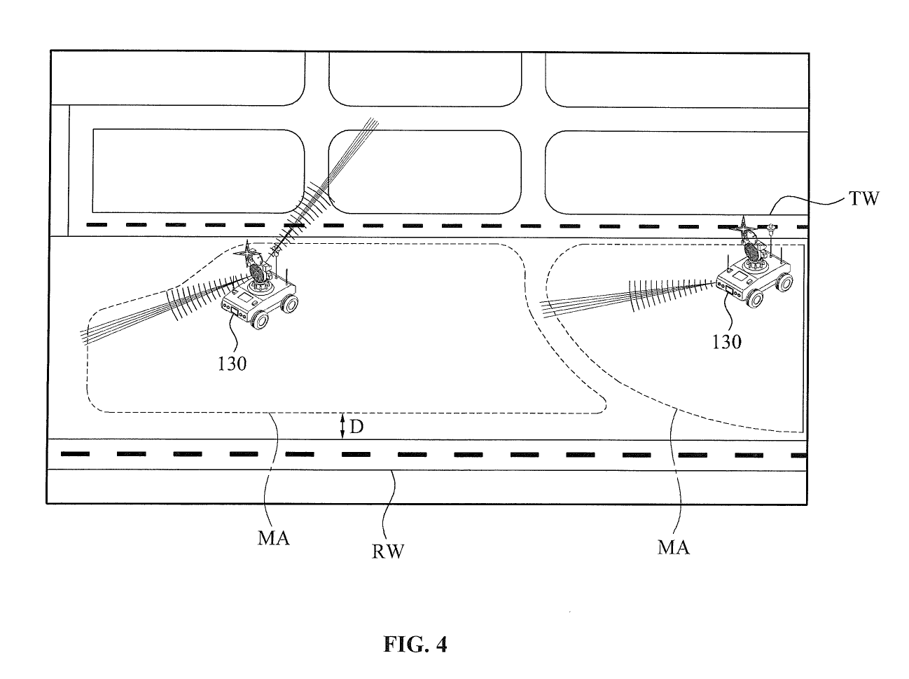

FIG. 1 is a diagram schematically illustrating the configuration of a bird countermeasure system 10 according to an embodiment of the present invention. FIG. 2 is a perspective view illustrating a bird countermeasure robot according to an embodiment of the present invention. FIG. 3 is a perspective view illustrating a bird detection unit 160 and a bird repellent unit 170 of the bird countermeasure robot illustrated in FIG. 2. FIG. 4 is a diagram illustrating an exemplary operation of the bird countermeasure robot illustrated in FIG. 2.

Referring to FIG. 1, the bird countermeasure system 10 according to the embodiment of the present invention may be configured in stages based on the distance between birds B and an access point AP, such as an airport and the like.

The bird countermeasure system 10 according to the embodiment of the present invention may include a long-range bird countermeasure unit 110 that detects the birds B located a relatively long distance, a short-range bird countermeasure unit 130 that detects and repels the birds B located a relatively short distance from the access point AP, and a medium-range bird countermeasure unit 120 the birds B located between the relatively long and short distances from the access point AP.

The long-range bird countermeasure unit 110 is used to detect or recognize a flying object or the like, which approaches the access point AP at a distance of about 40 km from the access point AP such as an airport, using radar. The long-range bird countermeasure unit 110 may recognize whether the flying object located a relatively long distance from the access point AP is a bird, and determine whether the recognized bird is approaching the access point AP.

That is, the long-distance bird countermeasure unit 110 may detect birds flying toward the access point AP from a relatively long distance using the radar, and may give a warning regarding the birds by detecting the presence of a flock of the birds, the size of the flock of the birds or the flight pattern of the birds and transmitting detection information to the access point AP.

Through the configuration described above, birds located a relatively long distance away can be detected from the access point AP such as an airport, and can be systematically detected or repelled based on whether the birds approach the access point AP. Also, it is possible to prevent the birds from approaching the access point AP by dealing with the birds from the long distance.

When the flying object detected by the long-range bird countermeasure unit 110 is recognized as a bird and it is determined that the bird is approaching the access point AP, the long-range bird countermeasure unit 110 may give a warning regarding the approach of the bird toward the access point AP. The access point AP that receives the warning may determine whether to repel the bird using the medium-range bird countermeasure unit 120 or short-range bird countermeasure unit 130.

In addition, the medium-range bird countermeasure unit 120 may deal with birds based on the result recognized or detected by the long-range bird countermeasure unit 110, or may independently deal with the birds regardless of the long-range bird countermeasure unit 110. The medium-range bird countermeasure unit 120 is used to detect or deal with birds located a distance of about 4 km from the access point AP. The medium-range bird countermeasure unit 120 may obtain detailed information on the birds. For example, the medium-range bird countermeasure unit 120 may recognize the types of the birds, the size of the birds, the flight pattern of the birds, and the like, and may determine whether to repel the birds or defer the repellent of the birds based on the recognized information.

In this case, the medium-range bird countermeasure unit 120 may obtain the detailed information on the birds using an infrared (IR) camera. The medium-range bird countermeasure unit 120 may obtain the detailed information on the approaching birds by disposing the IR camera at an outermost boundary or corner of the airport that is the access point AP.

In other words, the medium-range bird countermeasure unit 120 may detect the type and size of birds and repel the birds at a point at which the birds are detected. Unlike the long-range countermeasure unit 110, the medium-range bird countermeasure unit 120 may obtain more detailed information on the birds and determine whether to repel the birds using the obtained information.

In addition, birds that are not repelled by the long-range or medium-range bird countermeasure unit 110 and 120 or birds that fail to be repelled, despite an attempt of the bird repellent, may finally come very close to the access point AP or occupy the access point AP. Accordingly, the short-range bird countermeasure unit 130 is provided to detect or repel the birds that come close to the access point AP.

The short-range bird countermeasure unit 130 may detects or repels birds located a distance of about 0.5 to 1 km from the access point AP. While a location of the long-range or medium-range bird countermeasure unit 110 or 120 may be fixed, the location of the short-range bird countermeasure unit 130 may not be fixed and may be moved to repel birds. That is, the short-range bird countermeasure unit 130 may be configured in the form of a mobile robot or unmanned mobile vehicle so as to actively deal with birds. The short-range bird countermeasure unit 130 will be described in detail hereinbelow.

The long-range bird countermeasure units 110, the medium-range bird countermeasure units 120, and the short-range bird countermeasure units 130 described above may be operated independently or in conjunction with each another.

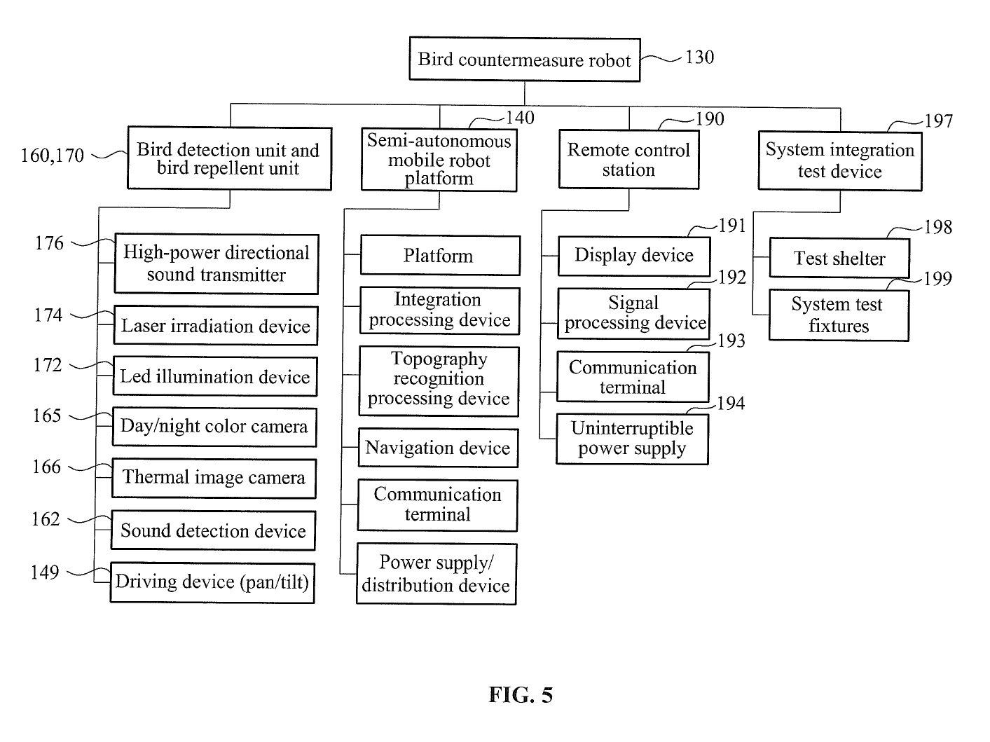

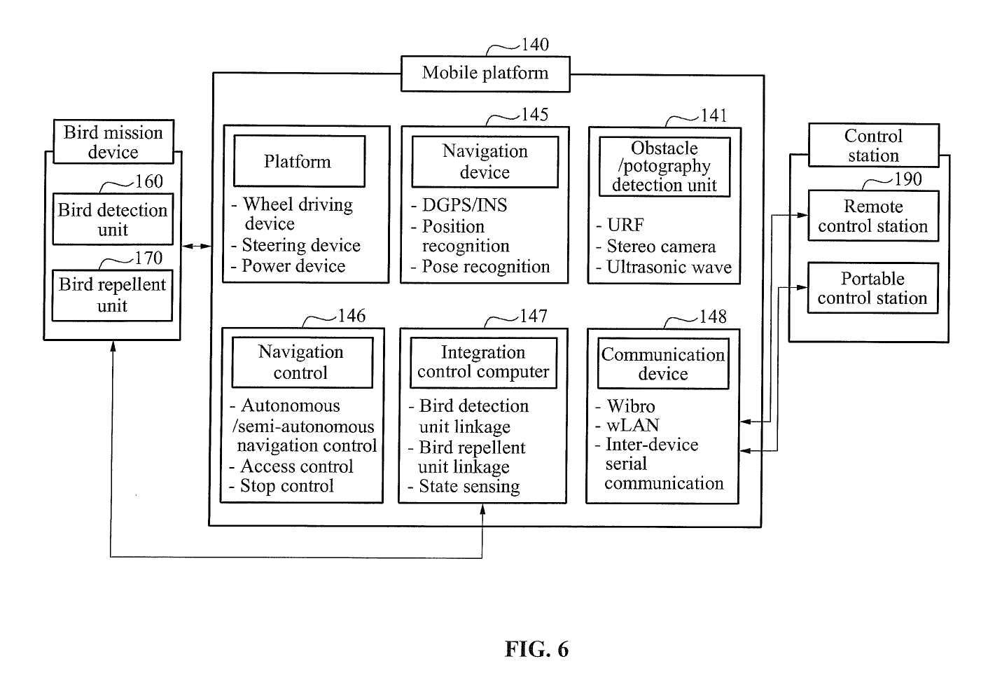

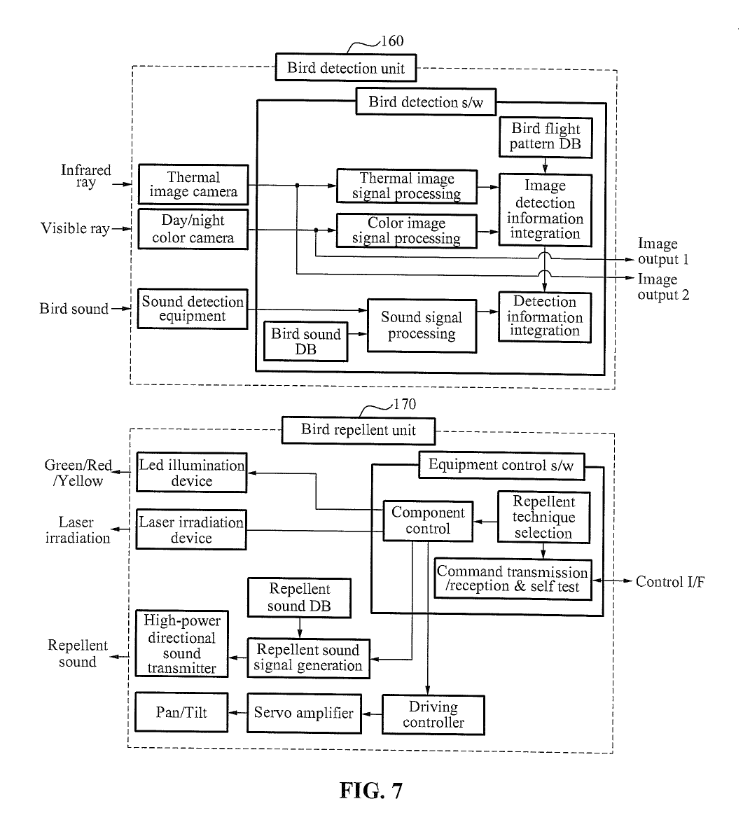

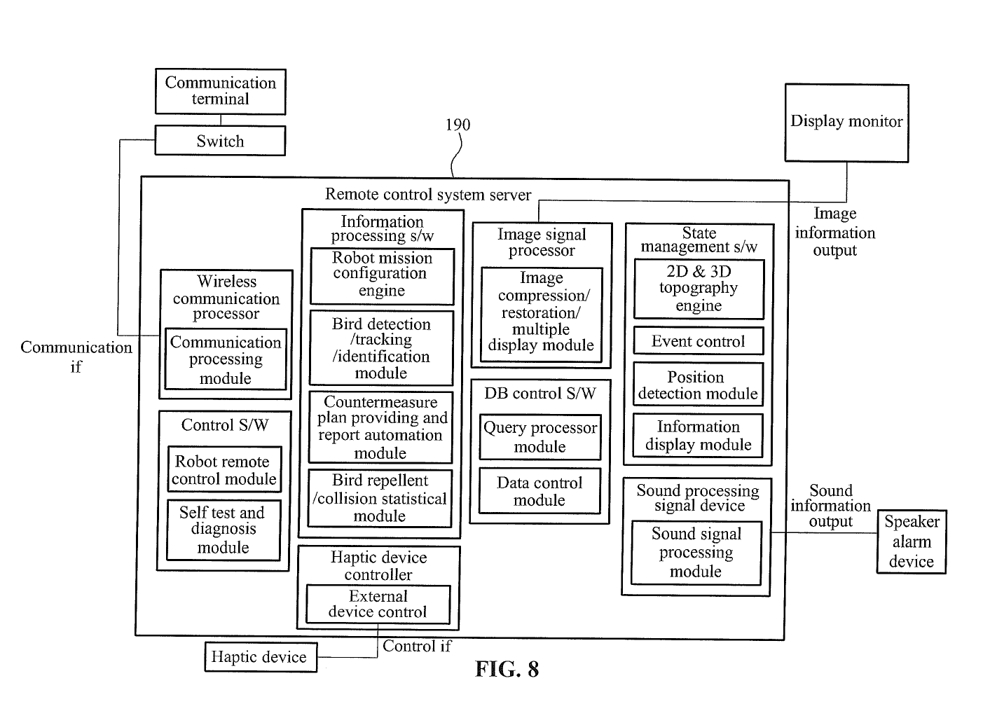

In addition, FIG. 5 is a block diagram illustrating the configuration of the bird countermeasure robot illustrated in FIG. 2. FIG. 6 is a block diagram illustrating the configuration of a mobile platform of the bird countermeasure robot illustrated in FIG. 2. FIG. 7 is a block diagram illustrating the configurations of the bird detection unit 160 and the bird repellent unit 170 of the bird countermeasure robot illustrated in FIG. 2. FIG. 8 is a block diagram illustrating the configuration of a remote control station of the bird countermeasure system 10 illustrated in FIG. 1.

Referring to FIGS. 2 to 4, the short-range bird countermeasure unit 130 may detect or repel birds located at the access point AP or a short distance from the access point AP while patrolling or moving in the access point AP. That is, the short-range bird countermeasure unit 130 may not be fixed to a specific location but actively search for birds so as to detect or repel the birds that approach a hazard zone.

The short-range bird countermeasure unit 130 may be configured as a robot or unmanned vehicle that can detect or repel birds while semi-autonomously moving in the access point AP. Hereinafter, a bird countermeasure robot 130 will be described as an example of the short-range bird countermeasure unit 130. However, the short-range bird countermeasure unit 130 is not limited to the bird countermeasure robot 130.

As illustrated in FIGS. 2 to 4, the bird countermeasure robot 130 may include a mobile platform 140 provided with a transportation device including driving wheels 143 to move in peripheral spaces of a runway RW illustrated in FIG. 1 or a taxiway TW illustrated in FIG. 1, a bird detection unit 160 provided above the mobile platform 140 to detect birds, a bird repellent unit 170 provided above the mobile platform 140 to repel the birds detected by the bird detection unit 160 in conjunction with the bird detection unit 160, and a communication unit 144 that transmits information detected by the bird detection unit 160.

When the access point AP at which birds are necessarily detected or repelled is an airport, the bird countermeasure robot 130 may patrol or move in the peripheral spaces of the runway RW or taxiway TW so as to detect or repel the birds that approach or come close to the runway RW on which airplanes take off or land or the taxiway TW on which the airplanes taxi from an aviation shed to the runway RW. The bird countermeasure robot 130 may provide a bird countermeasure system 10 operated by a remote mobile command.

By using an unmanned, semi-autonomous mobile robot configured as described above, the detection and countermeasure of birds can be smoothly performed, and failure in repelling due to the learning of the birds may be reduced.

In this case, the bird countermeasure robot 130 may be provided with tracks instead of the driving wheels 143. The driving wheels 143 or tracks may secure mobility regardless of various plants or open fields associated with the ground of the access point AP. That is, the driving wheel 143 or tracks may be provided with a suspension device (not shown) based on a state of the ground of the access point AP so that the bird countermeasure robot 130 can move anywhere.

Referring to FIGS. 5 and 6, the mobile platform 140 may be provided with a steering device, a power device, a navigation control device and the like, in addition to the suspension device. The mobile platform 140 may be formed using a vehicle body with characteristics of being lightweight, having strength, and having excellent heat generation or dissipation. An autonomous navigation control technique may be applied to the mobile platform 140.

The mobile platform 140 of the bird countermeasure robot 130 may perform semi-autonomous movement. To perform semi-autonomous movement, the mobile platform 140 may be provided with an integration processing device, a topography recognition processing device, a navigation device, a communication terminal, a power supply/distribution device, and the like.

As illustrated in FIG. 6, a navigation device 145 may recognize the location and pose of the bird countermeasure robot 130 or the mobile platform 140. Also, the navigation device 145 may use a technique in which a differential global positioning system (DGPS) and an inertial navigation system (INS) are combined with each other.

A navigation control device 146 may perform autonomous/semi-autonomous navigation control, access control, stop control, and the like. The integration control computer 147 or integration processing device may perform bird detection unit linkage, bird repellent unit linkage and state sensing. A communication device 148 or communication unit may perform wireless broadband (WiBro) communications, wireless local area network (WLAN) communications, and inter-device serial communications. To perform communications, an antenna 144 may be provided to the mobile platform 140.

In addition, an illumination device 142 for night navigation may also be provided to the mobile platform 140.

Also, the mobile platform 140 may be provided with an obstacle/topography detection unit 141 that detects and avoids an obstacle or topography located in front of the navigation path of the bird countermeasure robot 130. Through the obstacle/topography detection unit 141, the mobile platform 140 can make a detour around a region in which it is difficult to move by detecting and evading an obstacle or topography that is expected to collide with the bird countermeasure robot 130.

As illustrated in FIG. 6, the obstacle/topography detection unit 141 may detect an obstacle by using an Ultrasonic Range Finder (URF) using ultrasonic waves, by monitoring ambient environment using an omnidirectional image, or by detecting a topography or obstacle using a laser scanner. Alternatively, the obstacle/topography detection unit 141 may detect an obstacle using a stereo image. To detect an obstacle using a stereo image, the obstacle/topography detection unit 141 may be provided with a stereo vision camera (not shown).

The bird detection unit 160 provided above the mobile platform 140 may detect birds using at least one of an IR ray, a visual ray, or a sound. Accordingly, the bird detection unit 160 detects birds using various methods or means, thereby continuously detecting the birds regardless of the time for detecting the birds, the type of the birds, and the like.

Referring to FIGS. 2, 3, 5 and 7, the bird detection unit 160 includes a sound detection device 162, an omnidirectional camera 164, a day/night color camera 165 and a thermal image camera 166. The sound detection device 162 may use a parabolic reflector microphone technique, a signal amplification technique, and a signal processing technique. Here, the microphone technique is performed using a highly-sensitive non-directional and directional microphones, and the signal amplification technique is performed using a low-noise and high-gain receiving amplifier. Also, the signal processing technique is performed using high-speed digital signal processing or multi-digital signal processing (DPS).

By using the sound detection device 162, information on birds is obtained by detecting a variety of sounds produced by birds, and accordingly, a proper bird repellent means can be selected. Also, the bird sounds obtained by the sound detection device 162 may be compiled as a database, and the processed bird sounds may be combined with other detection information.

The omnidirectional camera 164 may obtain information on birds by obtaining an image of the front of the bird countermeasure robot 130. Also, the omnidirectional camera 164 may collect data on a flight pattern or reaction pattern for each type of birds by using such image information.

The day/night color camera 165 obtains color images for birds and the like and combines the obtained color images with various pieces of image detection information. A zoom lens may be applied to the day/night color camera 165, and the day/night color camera 165 may be provided with a protection device in consideration of rain, moisture, heat and the like. Also, the day/night color camera 165 may be designed to be less susceptible to electromagnetic interference (EMI).

The thermal image camera 166 may optimizes bird detection performance using a optimum temperature resolution, a focus distance, and the like, and may be provided with a protection device in consideration of rain, moisture and heat. Also, a cable may be designed in consideration of EMI.

As described above, an IR ray, a visual ray, and a sound are used for the thermal image camera 166, the day/night color camera 165, and the sound detection device 162, respectively, so that birds can be effectively detected.

In addition, the bird repellent unit 170 may repel birds using at least one of sound, a laser, and a light, or may repel birds by using different sounds based on the type of the birds or season. Also, the bird repellent unit 170 may repel birds using a laser at night, sunset, or sunrise. By repelling birds using various methods described above, birds can be actively repelled based on the type or environment of the birds, and it is possible to prevent the birds from becoming accustomed to the bird repellent methods.

As illustrated in FIGS. 2, 3, 5 and 7, the bird repellent unit 170 may include a light emitting diode (LED) illumination device 172, a laser irradiation device 174, and a high-power directional transmitter 176.

The LED illumination device 172 may be provided with an illumination protecting device (not shown) in consideration of rain, moisture and heat, and green/red/yellow LEDs may be used in the LED illumination device 172. Also, the LED illumination device 172 may generate a warning signal for repellenting the birds, or a signal for informing pilots about a situation with the birds and the location of the bird countermeasure robot 130. The power supply of the LED illumination device 172 may be designed in consideration of heat dissipation.

The laser irradiation device 174 may have an optical system for laser beam diffusion and generate a laser using a diode pumping technique. Also, the laser irradiation device 174 may generate a green laser using an optical parametric oscillator (OPO) laser.

Here, the laser irradiation device 174 of the bird repellent unit 170 may automatically stop the irradiation of laser when an irradiation angle of the laser is at a reference angle or more. The reference angle may be determined to be an angle that prevents interference with the sight of a pilot caused by a high irradiation of the laser for the bird repellent. When the irradiation angle of the laser is at an angle greater than the reference angle, the irradiation of the laser is stopped.

Control software for controlling the LED illumination device 172 and the laser irradiation device 174 is used in the bird repellent unit 170. The control software may perform the control of various components, the selection of a bird repellent technique, the transmission/reception of a command, and the like.

In addition, the high-power directional transmitter 176 may perforin parametric sound modulation using an optimal directional sound generation algorithm. Also, the high-power directional transmitter 176 may repel birds by transmitting a sound produced by each of the birds or a sound that annoy birds, or by transmitting a sound produced by a gun or a sound produce by a cannon. The high-power directional transmitter 176 may generate a bird repellent sound signal from the bird repellent sound database and transmit the generated signal.

Here, the bird countermeasure robot 130 may be provided with a pan/tilt driving unit 149 for driving the bird detection unit 160 or bird repellent unit 170 on the mobile platform 140. By using the pan/tilt driving unit 149, the operation range of the bird detection unit 160 or bird repellent unit 170 can be maximized.

As illustrated in FIGS. 2 and 3, the pan/tilt driving unit 149 includes a pan driving device 149a that rotates the bird detection unit 160 or bird repellent unit 170 on the mobile platform 140, and a tilt driving unit 149b that vertically moves the bird detection unit 160 or bird repellent unit 170 on the mobile platform 140. Also, the pan/tilt driving unit 149 may include a motor, a location sensor and the like, and a digital servo controller, a high-power pulse width modulation (PWM) amplifier and the like may be used for the pan/tilt driving unit 149.

Referring to FIGS. 5 and 6, the bird countermeasure system 10 may include a remote control station 190 that receives image or sound information obtained by the communication unit or communication device 148 of the bird countermeasure robot 130 so as to control the bird countermeasure robot 130. Accordingly, the remote control station 190 can determine whether to repel birds and store the obtained information.

The remote control station 190 may include a display device 191, a signal processing device 192, a communication terminal 193, an uninterruptible power supply 194 and the like. Here, the display device 191 may be a screen device for an operator that remotely controls the bird countermeasure robot 130. The display device 191 may be ergonomically designed to maximize safety and work efficiency. A portable control station may be further added to the remote control station 190.

When a communication error occurs between the bird countermeasure robot 130 and the remote control station 190, the operation of the bird countermeasure robot 130 may be stopped. When the bird countermeasure robot 130 is operated or moved even though a communication error occurs between the remote control station 190 and the bird countermeasure robot 130, the bird countermeasure robot 130 may collide with an airplane by entering into a flight safety zone or restricted flight zone. In order to prevent such an accident, the operation of the bird countermeasure robot 130 is stopped when a communication error occurs between the bird countermeasure robot 130 and the remote control station 190.

The configuration of the remote control station 190 is illustrated in FIG. 8. Referring to FIG. 8, the remote control station 190 may include various types of software such as information processing software and state processing software, and various types of hardware such as a wireless communication processor and an image signal processor.

The remote control station 190 may control the operation of the bird countermeasure robot 130 through wireless communications with the bird countermeasure robot 130 and diagnose the malfunction of the bird countermeasure robot 130. When the bird countermeasure robot 130 malfunctions, the remote control station 190 may diagnose the malfunction of the bird countermeasure robot 130, thereby stopping the operation of the bird countermeasure robot 130, and accordingly, it is possible to prevent the bird countermeasure robot 130 from colliding with an airplane or the like.

In addition, the bird countermeasure robot 130 may further include a system integration test device 197, a test shelter 198, system test fixtures 199 and the like.

The location of the bird countermeasure robot 130 according to the embodiment of the present invention may be detected in real time. When the bird countermeasure robot 130 approaches the runway RW or taxiway TW, the operation of the bird countermeasure robot 130 may be stopped. Accordingly, the collision of the bird countermeasure robot 130 with an airplane may be avoided by preventing, in real time, the bird countermeasure robot 130 from entering into an access-restricted zone.

When birds are detected or repelled using a plurality of bird countermeasure robots 130, it is possible to prevent the bird countermeasure robots 130 from colliding with each other by controlling each of the bird countermeasure robots 130 to operate only in a separate mission area MA.

As illustrated in FIG. 4, when two bird countermeasure robots 130 for bird countermeasure are provided at the access point AP, each of the bird countermeasure robots 130 performs a patrol, movement, detection or repellent operation only in a separate mission area MA. When a bird countermeasure robot 130 is outside its own mission area MA or enters into the mission area MA of the other bird countermeasure robot 130, it may be detected that the bird countermeasure robot 130 is located in a restricted area, and the remote control station 190 controls the bird countermeasure robot 130 to stop moving.

The bird countermeasure robot 130 may perform autonomous navigation by tracing the boundary line of the runway RW or taxiway TW. Accordingly, the bird countermeasure robot 130 can autonomously distinguish between navigation and non-navigation areas. As a result, it is possible to prevent the bird countermeasure robot 130 from colliding with an airplane. For example, referring to FIG. 4, the bird countermeasure robot 130 may approach only a point spaced apart from the runway RW at a constant distance D, and may be operated not to exceed the constant distance D. To approach only a point spaced apart from the runway RW at a constant distance D, the bird countermeasure robot 130 may recognize a navigation path or boundary line between mission areas MAs using the obstacle/topography detection unit 141 or the like.

In addition, the approach path along which the bird countermeasure robot 130 approaches from an initial location (not shown) to the mission area MA is determined. When the bird countermeasure robot 130 is beyond the approach path, the bird countermeasure robot 130 stops operation.

When the amount of fuel or charge of electricity is below a reference value due to its consumption, the bird countermeasure robot 130 may stop operation and return to the initial location. By returning to a predetermined location to refuel/recharge, it is possible to eliminate an inconvenience that operators are used to refuel/recharge.

By implementing the bird countermeasure system 10 including the aforementioned bird countermeasure robot and the like, it is possible to minimize the occurrence of bird strikes with airplanes.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A bird countermeasure system comprising:
a long-range bird countermeasure unit configured to detect birds located a long distance from an access point;
a short-range bird countermeasure unit configured to detect or repel birds located a short distance from the access point; and
a medium-range bird countermeasure unit configured to detect birds located between the long and short distances from the access point,
wherein the long-range, medium-range, and short-range bird countermeasure units are operated independently or in conjunction with each another.

2. The bird countermeasure system of claim 1, wherein:
the long-range bird countermeasure unit detects birds flying toward the access point from the long distance using radar; and
the long-range bird countermeasure unit detects the presence of a flock of the birds, the size of the flock of the birds, or the flight pattern of the birds, and transmits the detected information to the access point.

3. The bird countermeasure system of claim 1, wherein the medium-range bird countermeasure unit detects the type or size of the birds and repels the birds at a point the birds are detected.

4. The bird countermeasure system of claim 3, wherein the medium-range bird countermeasure unit detects the birds using an infrared (IR) camera.

5. The bird countermeasure system of claim 1, wherein the short-range bird countermeasure unit detects or repels the birds located at the access point or the short distance from the access point while patrolling or moving at the access point.

6. The bird countermeasure system of claim 5, wherein the short-range bird countermeasure unit comprises a remote control station that remotely controls a robot moved from the access point and an operation of the robot.

7. The bird countermeasure system of claim 6, wherein the remote control station controls the operation of the robot through wireless communications with the robot, and diagnoses a malfunction of the robot through wireless communications.

8. The bird countermeasure system of claim 6, wherein the robot operates only at a specific area in the access point and stops when the robot is out of the specific area.

9. A bird countermeasure system comprising a bird countermeasure robot configured to be operated through a remote command while patrolling or moving in an area adjacent to a runway or taxiway along which airplanes take off, land, or taxi to approach the runway or taxiway or to detect or repel birds located close to the runway or taxiway.

10. The bird countermeasure system of claim 9, wherein the bird countermeasure robot comprises:
a mobile platform configured to move in an area adjacent the runway or taxiway;
a bird detection unit configured to be provided to the mobile platform and to detect the birds;
a bird repellent unit configured to be provided to the mobile platform and to repel the birds detected by the bird detection unit; and
a communication unit configured to transmit information detected by the bird detection unit.

11. The bird countermeasure system of claim 10, wherein the bird countermeasure robot is provided with wheels or tracks and an obstacle/topography detection unit that detects and avoids an obstacle or topography located in front of a navigation path.

12. The bird countermeasure system of claim 10, wherein the bird detection unit detects the birds using at least one of an IR ray, a visual ray, and a sound.

13. The bird countermeasure system of claim 12, wherein the bird detection unit transmits image or sound information obtained by the communication unit to a remote control station.

14. The bird countermeasure system of claim 10, wherein the bird repellent unit repels the birds using at least one of a sound, a laser, and a light.

15. The bird countermeasure system of claim 14, wherein the bird repellent unit repels the birds using different sounds based on a type of the birds or season.

16. The bird countermeasure system of claim 14, wherein the bird repellent unit repels the birds using a laser at night, sunset, or sunrise.

17. The bird countermeasure system of claim 14, wherein the bird repellent unit automatically stops the irradiation of laser when the irradiation angle of the laser is a reference angle or more.

18. The bird countermeasure system of claim 13, wherein the operation of the bird countermeasure robot is stopped when a communication error occurs between the bird countermeasure robot and the remote control station.

19. The bird countermeasure system of claim 10, wherein the location of the bird countermeasure robot is detected in real time using a global positioning system (GPS), and the operation of the bird countermeasure robot is stopped when the bird countermeasure robot approaches the runway or taxiway.

20. The bird countermeasure system of claim 19, wherein a plurality of bird countermeasure robots are provided, and each of the bird countermeasure robots is operated in a separate mission area.

21. The bird countermeasure system of claim 19, wherein the bird countermeasure robot comprises a pan/tilt driving unit that drives the bird detection unit or the bird repellent unit on the mobile platform.

22. The bird countermeasure system of claim 19, wherein the bird countermeasure robot stops operation and returns to an initial location when an amount of fuel or charge of electricity is below a reference value.

23. The bird countermeasure system of claim 19, wherein the bird countermeasure robot performs autonomous navigation by tracing a boundary line of the runway or taxiway.
